(19) United States
(12) Patent Application Publication
(10) Pub. No.: US 2025/0292250 A1
(43) Pub. Date: Sep. 18, 2025

(54) Methods and Systems for Identity on Blockchain Clusters

(71) Applicant: Prem Makeig, Belfast, ME (US)

(72) Inventor: Prem Makeig, Belfast, ME (US)

(21) Appl. No.: 19/082,358

(22) Filed: Mar. 18, 2025

Related U.S. Application Data
(60) Provisional application No. 63/566,535, filed on Mar. 18, 2024.

(51) Int. Cl. G06Q 20/38

(52) U.S. Cl. CPC G06Q 20/389

(57) ABSTRACT

To solve the problems of fractured identity across multiple blockchains, these methods and systems allow for a single unified identity to be managed and resolved across multiple chains within an interop network. By leveraging message passing, identity records can exist securely across different chains. The system incorporates counterfactual blockchains, enabling trust-minimized name registration that reduces costs while maintaining decentralization and security. ENS name resolution is supported across both onchain and offchain environments, with verifiable proofs ensuring efficient resolution. By structuring message passing and utilizing decentralized indexers, these methods and systems provide a scalable and reliable framework for cross-chain identity.

### CROSS-REFERENCE TO RELATED APPLICATIONS

This application claims the benefit of U.S. Provisional Patent Application No. 63/566,535, filed on Mar. 18, 2024, which is incorporated herein by reference in its entirety.

### BACKGROUND OF THE INVENTION

To address blockchain scaling challenges, developers have introduced the concept of blockchain clusters—groups of interconnected blockchains that work closely together. In the case of Ethereum, these clusters function as rollups and inherit security from the base layer, Ethereum Mainnet, which is a layer-one blockchain. The goal of blockchain clusters is to enable seamless user interactions. For example, a user should be able to purchase a digital asset on one chain within the cluster using funds from another with just one or a few clicks. Wallets are also evolving toward chain abstraction, where users do not need to know which chain their funds are on or what chain a new asset belongs to, creating a smooth and intuitive experience.

A blockchain cluster can scale by adding more chains, allowing for massive scalability. This makes it possible for clusters to operate on a global scale, supporting millions of users. Additionally, scalability will be crucial for non-human users, such as AI agents. In the future, blockchain clusters could expand to include thousands of interconnected chains, all linked through a shared messaging protocol. Protocols are already being developed to support these blockchain clusters, including ERC-7786, the Cross-Chain Messaging Gateway.

ERC-7786 defines a standardized interface for smart contracts to send and receive messages containing arbitrary data across different blockchains. It establishes a unified gateway system that enhances interoperability between various cross-chain messaging protocols, enabling seamless communication while reducing reliance on specific vendors. The interface supports both native implementations and adapter contracts, ensuring compatibility with a wide range of cross-chain solutions. Messages include sender and receiver identifiers, a payload containing arbitrary data, and structured attributes that define additional execution parameters, making the system both flexible and extensible.

The workflow begins with a smart contract calling a source gateway to send a message, specifying the destination chain, recipient, payload, and any optional attributes. The source gateway, which is a smart contract, processes the request, emits an event for tracking, and transmits the message through a cross-chain messaging protocol. The destination gateway, also a smart contract, receives and verifies the message before invoking the target contract's execution function, ensuring that the message originated from a trusted source. The receiving contract processes the message only if it was delivered through an authenticated gateway, preserving the integrity of cross-chain communication.

ERC-7786 enforces key security guarantees, including message integrity, prevention of duplication, and compatibility with both EVM and non-EVM blockchains. Its modular design allows protocol-specific features to be incorporated while preserving a common core for basic message transmission. By providing a flexible yet standardized framework, ERC-7786 enables smart contracts to communicate across chains efficiently, securely, and without vendor lock-in, fostering greater interoperability in decentralized applications.

### Layer 2 (L2) Interoperability

Layer 2 (L2) interoperability for Ethereum is a complex and evolving area involving challenges related to address resolution, asset movement, messaging between chains, and executing cross-chain transactions. As Ethereum advances its rollup-centric roadmap, ensuring seamless interactions between different L2s, L3s, and non-Ethereum Virtual Machine (EVM) chains has become a priority. Various Ethereum Improvement Proposals (EIPs) and Ethereum Request for Comments (ERCs) have been proposed to standardize these processes, addressing core issues such as chain-specific addresses, cross-chain asset standards, message passing, and decentralized intent fulfillment.

One of the major challenges in Ethereum's multichain environment is identifying addresses across different rollups and sidechains, as the same address on one L2 might refer to an entirely different entity or contract on another. ERC-3770 introduces human-readable prefixes for Ethereum addresses, such as “eth: 0xAbC . . . 123” for Ethereum mainnet, with similar prefixes for rollups and other L2s, improving the user experience by reducing address ambiguity across chains. CAIP-10 provides a chain-agnostic way to reference blockchain accounts using formats like “eip155:1:0xAbC . . . 123” for Ethereum mainnet, allowing interoperability across blockchain ecosystems despite being less human-readable. ERC-7828 integrates chain-specific addressing into the Ethereum Name Service (ENS), enabling address mappings such as “alice@rollup” or “alice.rollup.eth,” which wallets can resolve directly onchain.

Ethereum's ecosystem, historically reliant on ERC-20, ERC-721, and ERC-1155 token standards designed for single-chain environments, has necessitated the development of cross-chain compatibility mechanisms. ERC-7802 introduces a cross-chain token interface that allows bridges to relay and transfer token balances across chains, standardizing cross-chain minting and burning while remaining flexible in its verification mechanisms. ERC-7281, also known as xERC20, introduces the concept of “sovereign bridged tokens” using a “Lockbox” mechanism, where existing ERC-20 tokens can be wrapped for cross-chain transfers while maintaining control over risk exposure through per-bridge rate limits.

Bridging solutions for cross-chain asset transfers generally follow two models: lock-and-mint, where tokens are locked in a smart contract on the origin chain and an equivalent amount is minted on the destination chain, and burn-and-mint, where tokens are burned on one chain and re-minted on another to maintain consistent token supply across chains. These frameworks ensure interoperability while minimizing liquidity fragmentation.

Beyond asset transfers, interoperability requires the ability to pass arbitrary messages between chains for governance, decentralized finance (DeFi) applications, and cross-chain execution. ERC-6170 defines a basic interface with “sendMessage” and “receiveMessage” functions for arbitrary data transfers between chains, while ERC-7786 extends this with additional attributes for proof-agnostic message verification and post-processing. ERC-7841 introduces a standardized message format that includes both metadata and payload, along with a Mailbox contract for storing and retrieving messages, allowing both push-based and pull-based bridging models.

ERC-7854 further decouples messaging from verification, introducing modular security mechanisms known as Interchain Security Modules (ISMs), allowing applications to select security models suited to their needs. These proposals form the foundation for standardized cross-chain communication, reducing fragmentation across different rollup ecosystems.

Intent-based execution is an emerging paradigm in interoperability, allowing users to specify desired outcomes rather than explicitly defining execution paths. ERC-7683 standardizes a framework for cross-chain value transfers, where “fillers” fulfill user intents by executing trades or swaps across multiple chains, with funds escrowed until conditions are met. Another approach, intent-based atomic swaps, introduces a trustless mechanism for asset swaps between L2 s without requiring cross-chain messaging protocols. This system ensures transactions either fully execute or fail, preventing partial execution risks. A novel extension of atomic swaps involves Pre-Hashed Time-Locked Contracts (PreHTLC), which introduce delegated secret management, multiple solver selection to reduce failure risks, and incentive alignment to ensure timely execution.

In this system, a user initiates a transfer via a decentralized application (dApp), selecting available solvers. An auction selects a solver, who generates a secret and locks funds on the destination chain. Local verification ensures the transaction is completed, after which the user finalizes the transfer by signing off on the hashlock. The solver then reveals the secret, releasing funds on both chains, enabling sub-30-second settlements without reliance on third-party validators.

Traditionally, blockchain networks have relied on off-chain registries to track chain identifiers, but these methods require centralized maintainers. ERC-7785 proposes using ENS for onchain chain identifier registration, allowing rollups to resolve metadata such as version, bridge, and chain ID. To reduce fragmentation and improve capital efficiency, shared bridges and cross-rollup liquidity pools have also been introduced. Shared bridges allow multiple rollups to interact using common L1 escrow contracts, reducing settlement delays, while cross-rollup liquidity pools enable liquidity to be pooled across rollups without requiring independent settlement transactions for each transfer.

Ethereum's L2 interoperability landscape continues to evolve, with ongoing efforts to standardize address formats, enable cross-chain asset movement, establish robust messaging protocols, and implement decentralized intent fulfillment mechanisms. The combination of ERC-3770, ERC-7828, ERC-7802, ERC-7281, ERC-6170, ERC-7683, and PreHTLC-based atomic swaps represents a comprehensive approach to solving the challenges of multichain interoperability. By integrating these technologies, Ethereum can develop a scalable, trustless, and efficient framework for cross-chain interactions, ensuring a seamless experience for users and developers across L2 s and beyond.

Achieving seamless interoperability within chain clusters remains an area of active research and development. In the case of Optimism and its Superchain, which aims to make a network of OP Stack chains function as a unified blockchain, key challenges include secure and low-latency message passing, cross-chain asset transfers without liquidity fragmentation, and trust-minimized execution across chains. The Superchain interoperability framework introduces protocols that allow OP Stack chains to read each other's state and enable native cross-chain transactions, bringing Ethereum closer to a fully interconnected multichain ecosystem.

### Superchain Interoperability Architecture

The core component enabling inter-chain communication in the Superchain is OP-Supervisor, a new service that every OP Stack chain must run alongside its rollup node and execution client. OP-Supervisor maintains a database of all event logs across chains in the Superchain cluster, verifying cross-domain messages by ensuring that log events actually occurred on the source chain. It also interacts with the Layer 1 (L1) consensus layer to determine the transaction safety of L2 blocks.

Cross-chain message passing operates through a two-step transaction process: first, an initiating message is emitted as a log event on the source chain, and then the destination chain processes the message through the CrossL2Inbox contract, which either validates the message or calls a contract. To ensure consistency and prevent fraudulent message execution, all messages must reference their originating chain ID, block number, and log index. The L2ToL2CrossDomainMessenger contract extends CrossL2Inbox to provide general message passing, securing cross-chain transactions and preventing replay attacks.

Superchain interoperability introduces native mint-and-burn token transfers, eliminating the need for wrapped assets or liquidity pools. The Superchain TokenBridge contract, built on top of the L2ToL2CrossDomainMessenger, enables seamless ERC-20 transfers by burning tokens on the source chain and minting an equivalent amount on the destination chain. The SuperchainERC20 standard, based on ERC-7802, ensures that all Superchain-compatible tokens follow a unified interface for cross-chain minting and burning. Additionally, Superchain ETH facilitates seamless ETH transfers across the Superchain interop cluster, with ETH locked in an L1 lockbox contract to ensure that all ETH circulating on L2 s remains fully collateralized.

To mitigate the risks of chain reorganizations (reorgs) and double-spending, Superchain interoperability classifies blocks based on safety levels. Unsafe blocks are available through the gossip protocol but have not yet been written to L1, while local-safe blocks are written to L1 but without all dependent blocks recorded. Cross-safe blocks are fully secured on L1 along with all their dependencies, and finalized blocks are fully immune to L1 reorgs. Cross-chain transactions can be executed with varying latency and security trade-offs. A sequencer processing a cross-chain message based on an unsafe block assumes a higher risk, whereas waiting for cross-safe or finalized blocks improves security but introduces delays.

The Superchain interop protocol operates through dependency sets, which define which chains can directly communicate with one another. A fully connected Superchain interop cluster ensures direct communication between all participating chains, reducing transaction complexity and latency. Chains outside this cluster must route messages through intermediary chains. Superchain interop also relies on predeployed contracts available at fixed addresses across all OP Stack chains, including CrossL2Inbox at “0x4200 . . . 0022” for low-level cross-chain message validation, L2ToL2CrossDomainMessenger at “0x4200 . . . 0023” for higher-level message passing with replay protection, and Superchain TokenBridge at “0x4200 . . . 0028” for ERC-20 token bridging.

To prevent fraudulent message execution, Superchain interop relies on block safety verification through OP-Supervisor. Chains can choose different security levels when processing messages, with unsafe initiating messages offering the fastest execution but the highest risk of reorgs, safe initiating messages requiring cross-safe status for reduced risk, and finalized initiating messages demanding L1 finality for the highest security at the cost of increased transaction latency. If an initiating message is found invalid due to an L1 reorg or sequencer equivocation, any dependent cross-chain transactions are rolled back to prevent double-spending.

For developers, Supersim provides a local Superchain simulation environment for testing cross-chain transactions, while Interop Devnet serves as a temporary public testnet for Superchain interoperability, enabling real-world testing of ETH and ERC-20 cross-chain transfers. Superchain interoperability is designed to provide a trust-minimized, low-latency framework for seamless cross-chain communication and asset transfers within the OP Stack ecosystem. By integrating OP-Supervisor, cross-chain messaging protocols, and native mint-and-burn token bridging, the Superchain aims to function as a unified blockchain while maintaining decentralization and security guarantees. Future developments will continue refining message validation, security mechanisms, and interop cluster governance to support a growing network of interconnected OP Stack chains.

### Self Protocol

It is also possible to imagine a cross-chain identity solution leveraging an identity protocol such as the Self Protocol. Self Protocol is a privacy-centric identity framework designed to verify the authenticity of a user's real-world credentials—specifically biometric passports—while minimizing the exposure of personal data onchain. At the core of its architecture is the notion of zero-knowledge proofs (ZKPs), where the system demonstrates that the passport data is validly issued and controlled by the user without revealing full details like name or birthdate.

To accomplish this, Self Protocol integrates two essential concepts: passive attestation (verifying data from the passport's embedded chip, signed by an official Document Signing Certificate) and active attestation (planned future support for protocols like Active Authentication, in which the passport's chip can sign a recent block hash, proving physical possession). By starting with passive attestation, the protocol can support a majority of biometric passports in circulation, as they store their identity information in standardized data groups (DG1, DG2, etc.), along with a signature validated by a country-level certificate chain (CSCA).

When a user scans their passport's NFC chip, the protocol accesses the data groups and the SOD (Document Security Object), which contain cryptographic hashes of the data as well as the final signature from the country's DSC. Self Protocol then checks that the DSC itself is recognized by referencing a Merkle tree of whitelisted DSC certificates, each leaf associated with the corresponding CSCA that approved it. In practice, the user's passport data (DG1 for textual info, DG2 for the photo, and potentially DG15 for a public key) is hashed and concatenated to form the eContent. The eContent is then signed by the DSC, whose certificate in turn is signed by the CSCA, closing the trust loop. To handle this chain of certificates efficiently onchain, Self Protocol first verifies any new DSC references against an existing Merkle tree of recognized DSC leaves, ensuring passports from unknown or potentially malicious issuers are flagged.

A pivotal component of Self Protocol is its zero-knowledge circuits, which rely on Groth 16 proofs for succinct verification on Ethereum-like blockchains. This approach necessitates a multi-party trusted setup, but offers practical advantages: proofs can be generated off-chain and verified in a single onchain transaction at low gas cost. In these circuits, cryptographic hashing schemes such as Poseidon or SHA variants transform the raw passport fields into commitments.

This design allows the system to validate signatures, confirm the authenticity of a passport's issuance, and store an “identity commitment” without publicizing the user's passport number or name. Further, by deriving an attestation nullifier from the passport's signature data, each passport can only register once, providing a degree of Sybil resistance. A separate action nullifier, typically formed by hashing the user's secret with a unique application scope, ensures that the same identity cannot exploit a single protocol multiple times.

After successfully registering, users no longer need to re-verify their entire passport for every interaction. Instead, they can present disclosure proofs that selectively reveal or withhold specific attributes—e.g., showing they are above a certain age, from a certain country, or not on a sanctions list—while still proving their identity is genuine.

This is done with a second, lighter circuit that references the previously committed identity in a Merkle tree onchain, confirming the user's personal secret (the one chosen at registration) and the hashed passport data align with the existing entry. The user can also attach a scoping parameter (like a website's domain) to produce unique action nullifiers for each application, thereby preventing cross-correlation of their activity. Because all passport data remains hidden apart from any specifically disclosed field, the system minimizes the risk of user tracking and large-scale data breaches.

By unifying all these elements—passport scanning, zero-knowledge proof circuits, Merkle trees for DSC/CSCA validation, and selective attribute disclosure—Self Protocol aspires to create a trustless, permissionless identity infrastructure suitable for decentralized ecosystems. The ability to confirm that an individual is a unique person (Sybil resistance) or meets certain real-world criteria (like nationality or age) is critical in many onchain contexts, including airdrops, governance, or compliance checks.

Moreover, Self Protocol's design is intentionally modular: new certificate authorities can be added as more countries adopt advanced signing methods, and upcoming support for Active Authentication will strengthen protections against attackers who have briefly accessed someone's passport data. Ultimately, this architecture is positioned to work seamlessly in environments like chain clusters or rollup ecosystems, such as the Superchain, providing a robust and privacy-preserving identity layer for next-generation decentralized applications.

### Ethscriptions

A concrete illustration of an event-centric approach is found in Ethscriptions, where synthetic assets on Ethereum Mainnet rely solely on event logs rather than storing the entire asset payload in contract state. Under the proposed ESIP-1 (Smart Contract Ethscription Transfers), a contract that holds an Ethscription can emit an ethscriptions_protocol_TransferEthscription event to signal a valid transfer of ownership, so long as the contract actually owns that Ethscription at emission time.

### ENS

The Ethereum Name Service (ENS) is a decentralized, blockchain-based naming protocol that maps human-readable names (e.g., example.eth) to machine-readable identifiers. ENS operates on Ethereum smart contracts, ensuring censorship resistance, security, and full user control over domain ownership. ENS supports multiple record types, including address records (associating names with cryptocurrency addresses across different chains), contenthash records (storing links to decentralized storage like IPFS or Arweave), text records (holding arbitrary metadata such as email, URLs, avatars, and social media handles), ABI records (containing contract interfaces for smart contract interaction), and DNS records (enabling interoperability with traditional domain name systems).

Additionally, ENS includes public key records (for cryptographic verification and authentication), reverse records (allowing Ethereum addresses to resolve back to ENS names), and name records (enabling one ENS name to alias another). This flexible and extensible design makes ENS a foundational component for Web3 identity and decentralized applications.

### BRIEF SUMMARY OF DRAWINGS

FIG. 1 shows a diagram of a user updating an identity on multiple blockchains, as well as from offchain data sources, and a client reading the identity from multiple blockchains, all within a chain cluster connected using an interop protocol.

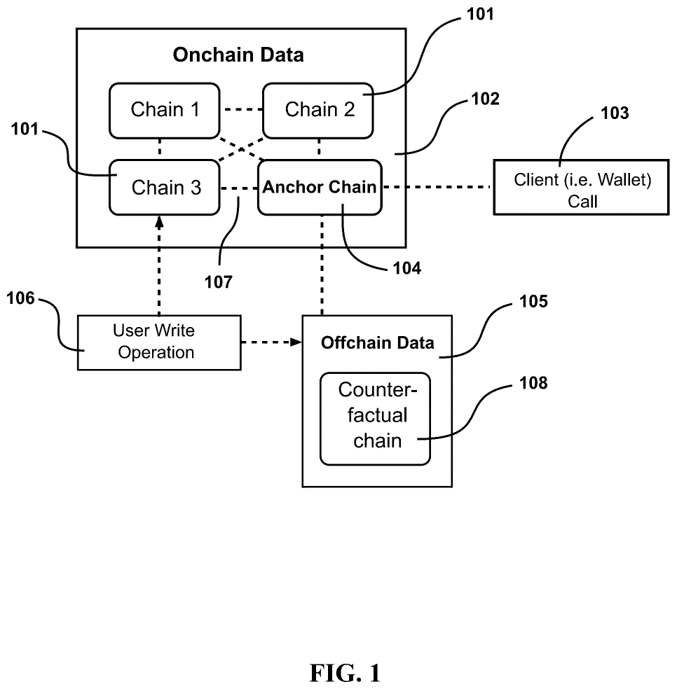

FIG. 2 shows the steps for registering a blockchain domain using more than one blockchain with an interop protocol.

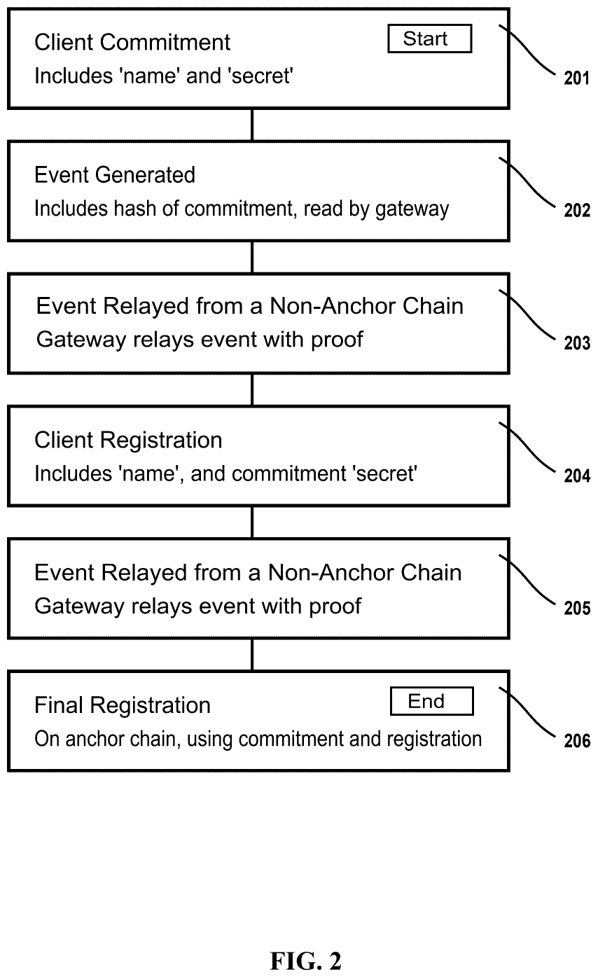

FIG. 3 shows the steps for adding a name record to an identity using more than one blockchain with an interop protocol.

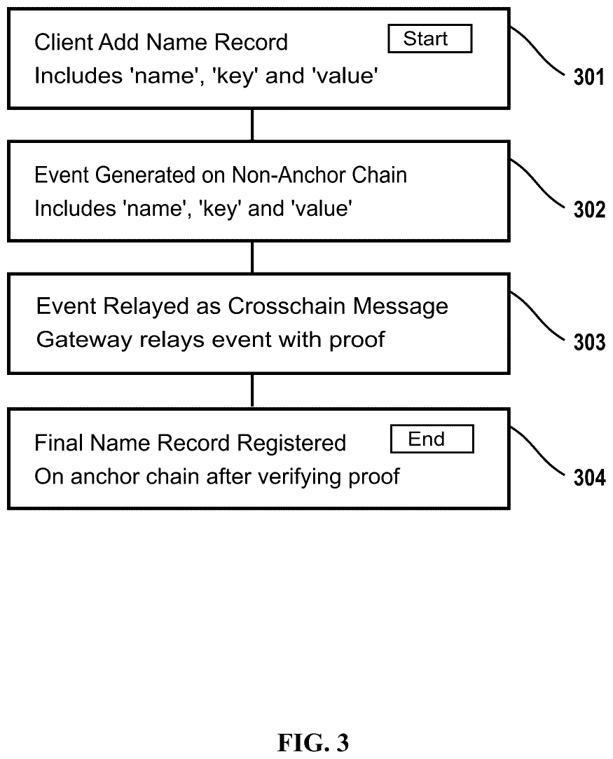

FIG. 4 shows the steps for setting up a name to offer subnames and registering a subname.

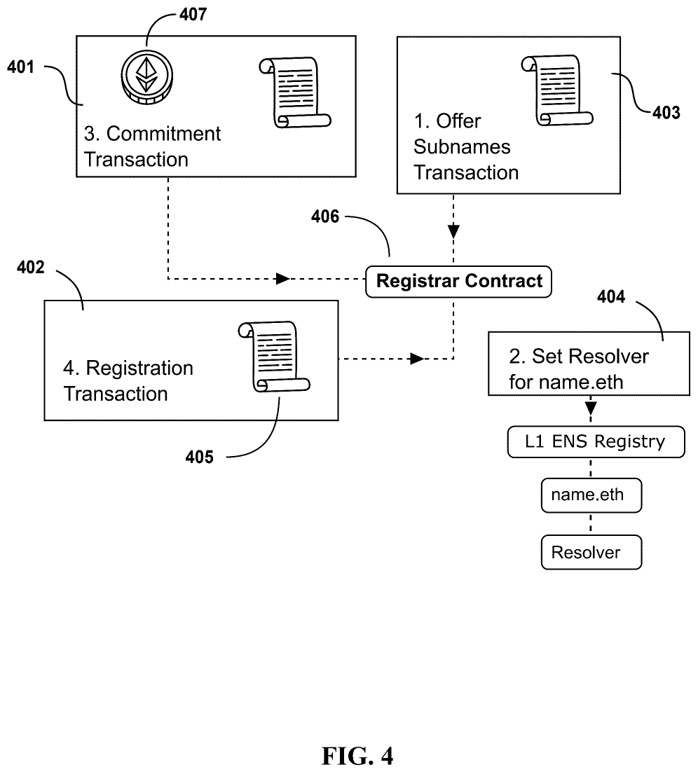

FIG. 5 shows the steps for resolving a subname using an offchain resolver, ERC-3668, as well as fetching the record from an offchain indexer.

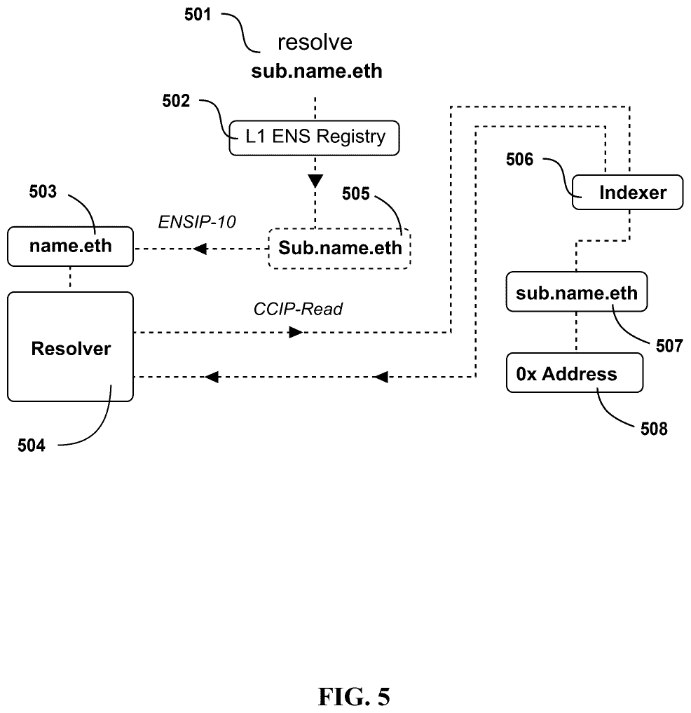

FIG. 6 shows a DApp interface where a user can register a subname.

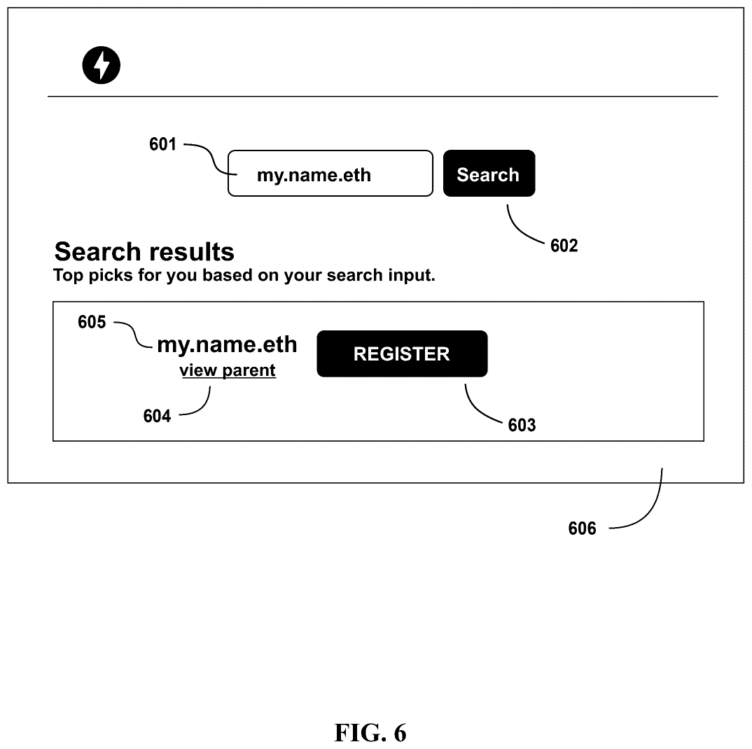

FIG. 7 shows the steps for resolving a name using more than one blockchain within a blockchain cluster with an interop protocol.

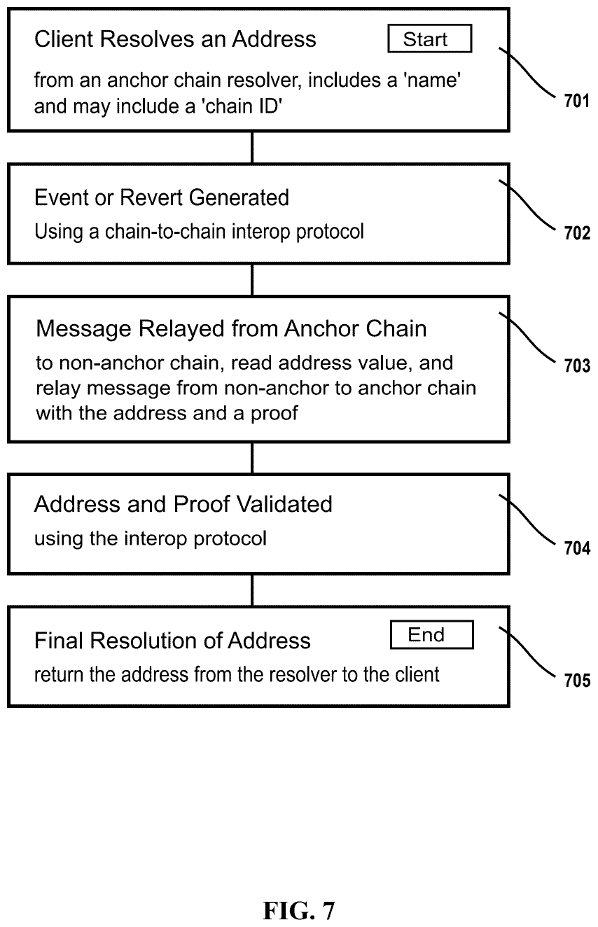

FIG. 8 shows a diagram of various records of an onchain identity stored on multiple blockchains, as well as offchain, using a counterfactual blockchain, connected using an interop protocol.

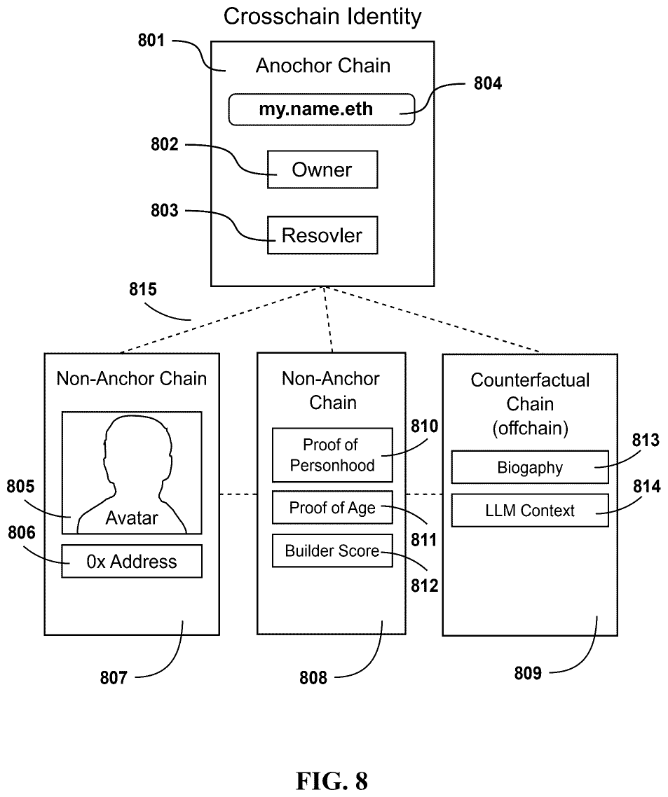

FIG. 9 shows an onchain identity being resolved using a single call to multiple blockchains, all connected using an interop protocol.

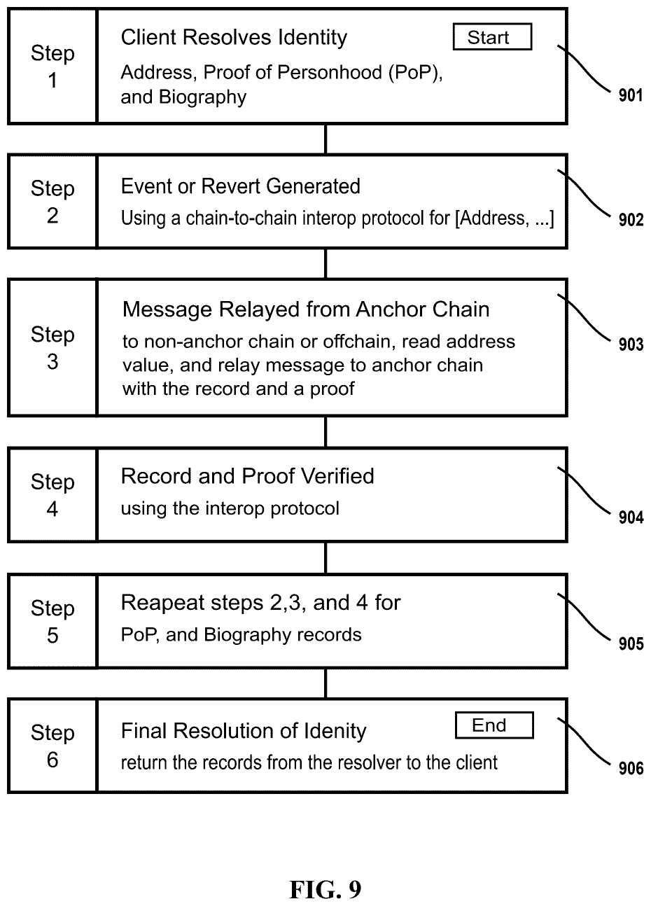

### SUMMARY OF THE INVENTION

The present invention includes methods and systems for developing an identity that operates across multiple blockchains, including blockchain clusters that comprise interoperability standards and methods (interop) to tightly couple chains for heightened interoperability. In this specification, we detail ways that a single identity, comprising a ‘name,’ which could be a blockchain-based name such as my.name.eth, or another name identifier, such as a file name or first name, can comprise various records, including avatar records, social media handles, media files, attestations, and others saved across multiple blockchains, as well as counterfactual blockchains and offchain records.

The fundamental technology that is leveraged to create a single identity across multiple blockchains, whether that is the identity of a human user, an AI agent, or a named item of content, including images, sound files, and documents, is message passing. Message passing leverages observable, verifiable blockchain artifacts, such as transaction calldata, events, reverts, or return data, that can be used for message passing between chains. There are many different interop technologies, which include bridges. Interop protocols depend on being able to verify that an action has taken place on one chain in order to take an action on another chain. To save gas, which is a unit of computing on blockchain networks, it is even possible to take actions in a counterfactual way, wherein a second blockchain transaction never actually takes place, but observers of the interop system may still be able to deterministically verify the intended outcome.

For example, a message passed from a first chain to a second chain that contains calldata, which calls a function on a counterfactual contract (a contract that is not actually deployed but can be deployed if necessary), can still trigger an event within that counterfactual contract, as long as the contract data is known. The event will not become part of the second chain's event logs; however, an observer of the system can determine what the result of the action on the second chain is using counterfactual analysis. This is sometimes called “lazy” execution, where the execution of the calldata is not actually executed onchain, but a trustworthy observer—or an observer that can supply a proof—can execute the calldata or crosschain message in a counterfactual way, which results in a deterministic outcome, such as minting a token or registering a blockchain domain.

It is also possible for entire blockchains to be counterfactual, where these counterfactual blockchains receive messages from a set of interconnected chains sharing a single interop protocol. In the case of a counterfactual blockchain, the blockchain is simply identified by a chain ID, but the blockchain is never deployed. However, it is possible to simulate the state of the counterfactual blockchain simply by executing the transactions received at the chain ID from the interop protocol.

Counterfactual blockchains are particularly useful in cases where the primary motivation of the chain is non-financial in nature, such as identity. Counterfactual blockchains are cryptographically secure because their state is deterministic, based on the sequence of messages passed from other chains in the cluster.

Clients that wish to read from a counterfactual blockchain are able to use their own indexer, which can verify the state of the chain either by executing every transaction from the genesis block or using a proof, such as a ZK proof, to verify the execution. Counterfactual blockchains can also be decentralized because anyone can run their own simulation of the chain and read data only from their own indexer, or there can be a decentralized set of trusted indexers, allowing decentralized reading of the chain.

There is a set of technologies that many types of interop solutions, bridges, and counterfactual systems use, which may include verifiable message passing using verifiable blockchain artifacts or variable blockchain actions (VBA), such as transaction calldata, events, reverts, return data, and blobs. What all VBA has in common is that the data is verifiable using the source blockchain, even if the data is not stored in the storage of the blockchain itself.

VBA is often included in the blockhash, for example, in the form of a Merkle-based hashing scheme. It is also possible to combine onchain storage with VBA for interop systems or payment with VBA. For example, Ethscriptions, an EVM-based inscription system, saves ownership offchain in a counterfactual way, wherein the owner of any asset can only be determined using VBA, including calldata and events submitted on a root or anchor blockchain.

### DETAILED DESCRIPTION OF THE INVENTION

In embodiments of this invention, an identity or name registry typically resides on a single “anchor” chain 104, while other chains within a cluster (chains interconnected using interop using message passing) can have clones of the registry or counterfactual deployments, which may not be deployed onchain, but observers are able to counterfactually interpret the results of onchain calls to these counterfactually deployed contracts. It is also possible to have chains within the cluster that are entirely counterfactual, where both the chain itself and the contracts deployed to the chain exist only offchain. When a user action-such as a name registration or record update 106—occurs on a non-anchor chain 101, the chain emits an event containing the contents of a message, which could be from a counterfactually deployed contract, according to a standardized message passing protocol.

The anchor chain 104 then receives the message (e.g., via cross-chain messaging relays, gateways, or offchain indexers) and updates the registry or resolver records accordingly. This mechanism allows user identities, including human users, AI agents, and named multimedia content items, to exist across multiple chains without requiring full duplication of the underlying data. In some cases, a non-anchor chain 101 also stores data, which could be a hash of a multimedia file, such as an image or sound recording, or it could be an attestation, which may be a zk-based attestation, as well as emitting an event. The event may include a reference to one or more of the chain ID, destination contract address, ID of the data, storage location of the data, and an inbox ID, a special identifier used for cross-chain messaging protocols. In this way, it is possible to associate data stored on a non-anchor chain with the identity, such as a root name, stored on the anchor chain.

When reading records from the anchor chain 104, a resolver can be used, and the associated data value may be on a non-anchor chain 101 or stored offchain, such as using a counterfactual blockchain 108, and retrieved using a trusted indexer 506 or gateway. It is also possible to receive a proof with the offchain saved data, verifying the execution of all of the offchain transactions leading to the contemporary state of the counterfactual blockchain, proving the correctness and accuracy of the data. The proof could be Zero-Knowledge (ZK) based, allowing for fast verification of the computation of the saved data in the counterfactual blockchain.

When resolving records from a non-anchor chain 101, starting with the anchor chain 104, the method for reading the value may be the same or similar to ERC-3668, wherein a client, when attempting to read the value from the anchor chain 104, receives a revert message or any form of VBA, and the revert message directs the client to a URL gateway API, where the value can be fetched from the non-anchor chain or counterfactual chain (offchain) using an indexer, along with a proof, which is verified on the anchor chain using a callback function. It is also possible to use the native interop protocol of the chain, such as ERC-7786, or other similar protocols. In some cases, the client can supply their own gateway, such that the costs associated with gateways are maintained by the client itself.

It is also possible to retrieve multiple values at the same time with a single multicall to the resolver or to a universal resolver, a smart contract that handles making multiple calls to a single resolver. It is therefore possible to make a single call to a universal resolver or the resolver itself and retrieve identity records, such as the name, text records, media records, or other standard ENS records.

One key primitive for creating onchain identity is ENS (Ethereum Name Service), which is widely used in the Ethereum ecosystem to provide a name for users, including wallet addresses, avatars, d-websites, social handles, and more. Many implementations pair offchain records with onchain records to optimize efficiency and verifiability. Indexing services or private APIs store richer metadata while keeping only references (such as hashes) onchain. This reduces onchain storage costs while preserving verifiability.

Counterfactual registration allows a record to be registered without storing it onchain. This enables identity records to exist without requiring gas fees. In some cases, a hash (such as a CID) can be registered using Verifiable Blockchain Artifacts (VBA), such as an event log or call data. This ensures that even offchain databases that contain raw data remain verifiable because the hash is saved as VBA. Publicly verifiable transaction histories—through event logs, call data, or blobs—allow trusted offchain data to prove that any claimed identity update is backed by an actual, canonical event on an anchor or non-anchor chain.

Cross-chain identity operates using a layered approach. The primary registry on an anchor chain saves the authoritative record, such as a name. This establishes a single source of truth. Offchain indexers store additional data, such as large images. Non-anchor chains store additional records, such as attestations, avatars, text, or binary data records. The retrieval process may begin with the anchor chain, which serves as the trusted entry point for resolving identity data. Data that is either on a non-anchor chain or offchain, such as a counterfactual chain, can also be read as part of the layered approach using native interop or a resolver-specific interop solution such as ERC-3668.

One example of an offchain record 105 could be a large image file. The hash of the large image file, along with a URL or CID (content identifier), could be stored onchain 102, and the actual data of the image could be stored offchain 105. When a client reads the record of the image hash that is stored onchain, it can fetch and verify the full set of image data offchain. In this way, large images can be associated with an identity, for example, an avatar image, without requiring large amounts of data to be stored onchain.

In this way, it is possible to maintain records across multiple blockchains that are all part of a single identity, which can be called by clients from an anchor chain 104 using a smart contract ABI that is uniform. When a record does not exist on the anchor chain 104, it is possible to direct the client to fetch the data from a non-anchor chain 101 using a gateway or directly from the non-anchor chain using a direct connection such as an RPC server. It is also possible to use the native interop protocol of the chain cluster using message passing to resolve records from a different chain (crosschain records).

Native interop, such as the Superchain Interoperability Architecture (SIA), can also be used, which may include a Supervisor that can securely relay messages 107 between chains. In this case, the native interop can be used for both reading records as well as updating and adding records on either the anchor or non-anchor chains.

For example, an address record, which could be a 0x address, such as an Ethereum address, can be resolved, starting with a client 103 calling a registry or resolver using a “resolve” or any address reading function, with arguments that might include a name and a chain ID 701. The function call results in VBA, which could be an event, revert, or return data 702 that may contain a target chain ID where the data is saved, a URL of a gateway, the target contract address where the address record is registered, and possibly an inbox ID, used specifically for cross-chain messages. The message is then relayed 703 to the target chain, where the message can be validated 704. Next, the target contract address is used to call the target contract to resolve the address record 705. The order of these steps does not have to take place in exactly this order. It is possible, for example, that the validation of the message is done after calling the target contract to get the address value.

### Resources ENS Records

It is possible to create a new type of identity record that could be a standard part of ENS records—one that is a mapping from string->bytes or uint->bytes. Currently, there exists only one ENS record, contenthash, that can be used to store bytes. It is not a mapping and therefore cannot be used to store more than one record. The record type could be called Resources and be targeted at securely storing onchain resources for AI agents.

In some cases, the actual stored value onchain is an IPFS address, such as a CID (content ID), which is generated using a hash of the content and is therefore unique to the content. Just like the contenthash record, it is possible to use multicodec formats as a standard, which includes many types of formats such as IPFS, IPNS, HTTPS, and more.

### Resolving Identities

It is also possible to resolve a complete identity by resolving multiple records at the same time, which is sometimes called a multicall. For example, a client can, starting with the anchor chain 801, create a multicall to the resolver of the name 804, which has an owner 802, or use a Universal Resolver contract to resolve a set of identity values, which could include a blockchain address 806, an avatar record 805, proof of person (PoP) 810, proof of age 811, and a builder score 812.

In one embodiment, the first step is that the client makes a multicall on the anchor chain 901, 801, where the resolver 803 is found to resolve records, including an address, PoP, and biography 813. For each record not on the anchor chain, on a non-anchor chain 807, 808, or counterfactual chain 809, an event is emitted 902. It is also possible for records on the same chain to be batched together into a single event. The event is relayed as a message to the target chain of the record 903, such as the address record, where the message is verified 904. The non-anchor chain could also be a counterfactual chain or an offchain database. A proof may also be generated and relayed to the target chain.

For each record, a message is relayed to the target chain, and a message may also be relayed back to the anchor chain 903. A proof may also be generated from the target chain, which may be verified on the anchor chain 904. In this way, each record can be read from the target chain until all the records of the identity have been read 905, effectively resolving an identity in one resolution call to a resolver 906.

In some embodiments, the steps of resolving all the records of an identity may occur in a different order. For example, the proofs may be verified on the anchor chain, the target chain, neither, or both. It is also possible that a message is sent from the anchor chain to the target chain but not the other way around. Additionally, a write operation may take place while resolving an identity, such as updating a record or nullifying an identity nullifier. It is also possible that the interop protocol relayers verify the messages offchain using a Merkle-based proof or a ZK-based proof.

### Secure MCP Servers

The described system may employ the Model Context Protocol (MCP) server or any similar agent SDK to resolve context for artificial intelligence (AI) agents using blockchain identity records compliant with Ethereum Name Service (ENS) record standards. MCP servers commonly utilize standard transports such as Server-Sent Events (SSE) and standard input/output (stdio) to facilitate real-time communication between clients and servers.

MCP standardizes interactions for Large Language Models (LLMs) by clearly separating context management from LLM interactions themselves. MCP servers specifically use resources (data retrieval similar to REST API GET endpoints), tools (executable operations akin to REST API POST endpoints), and prompts (reusable templates guiding interactions with LLMs).

When a user requests an operation, such as swapping 100 Pepe tokens for ETH through an AI agent identified by a blockchain identity like uni.eth, the MCP server resolves the identity to fetch structured data stored directly in blockchain identity records or indirectly via URIs, IPFS Content Identifiers (CIDs), or gateway URIs with CIDs.

Critical to this process is ensuring token authenticity, achieved by referencing an authoritative token registry such as tkn.eth, where official tokens, such as pepe.tkn.eth, are registered and verifiable. Once token authenticity is confirmed, the MCP server retrieves essential data, including the correct Uniswap pool address associated with the token pair and the necessary interface for executing the swap operation. Additionally, the MCP server acquires token pricing data and defined slippage tolerance to accurately facilitate DeFi transactions.

The MCP architecture may leverage ENS's Resources records' capability to store resources (or context 814) data securely, whether entirely onchain or using a CID to resolve offchain from IPFS or other decentralized storage systems, with data authenticity and integrity easily verified against onchain CID records. It is also possible to use any type of identity record, such as ENS text records, to store data used in the operation of an MCP server, including resources, tools, and prompts. Moreover, interoperability protocols such as ERC-3668 enable MCP servers to flexibly retrieve identity and context 814 data across multiple blockchains, counterfactual blockchains, or offchain servers, enhancing decentralization and robustness in resource (also context) management. A resource can be any kind of data used in the context of an LLM for use with an AI agent.

MCP servers utilize tools to execute operations based on the retrieved and verified resources. In the token swap example, the MCP server constructs a structured transaction proposal specifying contract addresses, swap function interfaces, input parameters, and additional constraints like slippage limits. The resulting transaction prompt is then delivered to the client, enabling a user to securely review, sign, and submit transactions to a blockchain, thereby streamlining blockchain interactions via AI-driven interfaces.

### Registering Names

When registering a name such as name.chain.eth or name.chain.id, which can be at least one of an ENS name or a DNS name, a client could be a blockchain wallet that is connected to a DApp 606. The DApp may have a search box 601 to search for available names. When a user searches for names by clicking on the search box 602 and finds an available name 605, the user can click on the register button 603. The user can also click on a button for more information about the parent name 604, such as the owner, the cost of renewals, etc.

The DApp can then prompt the user to sign and send one or more user operations 201, 204. A user operation can be any form of action taken by a user to initiate a blockchain action. For example, it could be a signed user operation used with a smart account, such as ERC-4337, or a blockchain transaction using an EOA (Externally Owned Account), an inscription with calldata, etc. The user operation can also include payment, for example, using the native currency of the chain, such as ETH, or another payment method, such as authorization to spend a vault balance or a gas reserve balance.

In the case that the operation results in a transaction or blockchain call and is directed to a non-anchor chain, the function will result in a VBA, such as an event 202, 203, 205. The event can be an interop protocol event, such as those specified in ERC-7786, or a native interop format, for example, OP native interop SIA. The event will contain structured registration data, such as calldata, which may contain key arguments for registering the name, such as the name, the owner's address, a manager's address, and the duration of registration. It may also be necessary, to prevent front-running, to first submit a commitment operation 201 before submitting a registration operation 204.

In the case where the registration is done on a non-anchor chain 101, a registrar contract can be used to register the name. It is also possible for the registrar contract to be counterfactually deployed. In some cases, tokens or a native cryptocurrency used for gas and payment for the registration of the name are made on the non-anchor chain, or the payment is made by a paymaster that sponsors the gas on the anchor chain 104, for example. In some cases, it is necessary to first submit a commit operation 201, where the arguments of the commit comprise a hash (the commit), which may be a hash of one or more values, including a name, the date, block number, a manager's address, an owner's address, a nonce, and a secret value, such as a number. The hash function can be any hash function, such as Keccak-256, SHA-256, BLAKE3, or Poseidon, depending on the security, efficiency, and compatibility requirements of the system.

A successful registration starting with a non-anchor chain requires that the initial operation, which can be a two-step process of first sending a commit operation 201 and then sending a registration operation 204, is relayed by a message-sending gateway or relayer 203, 205 to the anchor chain, where one or more of a registrar or registry smart contract exists that can be used to register the name 206 using the message-passing service, as well as validating that the message passed from the non-anchor chain was authentic. In some cases, only the registration operation 204 is needed without requiring a commitment.

It may also be necessary to pay for the registration using a native cryptocurrency or a token, such as ETH or USDC. The payment can be made using a balance of the original sender or paid on behalf of the original sender. It may also be necessary to verify a proof to ensure the message passed from the non-anchor chain was authentic. The proof may be a batch proof that has multiple user operations, transactions, or messages, all validated at the same time using a Zero-Knowledge Proof (ZKP).

A successful registration enables the sender of the user operation to own and control the name, such as name.chain.id or name.chain.eth, as well as set the resolver of the name. In some cases, the resolver of the name is set by default to a specific resolver or is the same smart contract as the registry.

It is also possible to add records to an identity on any chain within the chain cluster. The client can initiate a user operation add-record transaction on a non-anchor chain 301 using a resolver, which could also be a counterfactually deployed resolver, which emits an event 302. The event is relayed 303 as a cross-chain message to the anchor chain, and the name record is registered 304 on the anchor chain. The name record could be a text record, such as an avatar record, a contenthash record, or any type of identity record.

### Web Applications

It is also possible for an identity to comprise a web application, which can be stored either onchain or offchain. Offchain storage can use a CID, such as with IPFS or Arweave, referencing the application while minimizing onchain costs, with IPFS supporting content types like DAG-PB, DAG-CBOR, and DAG-JSON for structured data. Fully onchain storage allows the web application (i.e., website) to be encoded and saved using formats like DataURL, JSON, or other structured encodings that support multi-page applications. The DataURL format enables storing an entire web page as a single encoded string, such as “data: text/html,<html><body>Hello, world!</body></html>”, which decodes into a minimal webpage displaying “Hello, world!”.

The contenthash field in ENS supports multicodec encoding, allowing protocols like IPFS and Swarm to be used. DataURL support and URI support extend the multicodec approach by introducing two new protoCodes, uri and eth-calldata. The eth-calldata protoCode enables a resolver hook-like function: function hook (bytes32 node, string calldata key, address resolver, uint256 coinType) public returns (string memory), where key follows the format ”“+<Reverse ENS Name>+”: dataURL”, e.g., “eth.vitalik: dataURL”. This structured approach ensures that Data URLs and URIs integrate seamlessly with ENS, allowing browsers and gateways to resolve content efficiently while maintaining full compatibility with web3 identity standards. Additionally, a dedicated DataURL multicodec can be used.

Web applications can also be stored offchain, in a counterfactual contract, or on a counterfactual chain. In the case that a DataURL is saved in a counterfactual contract, it is possible to prove to the anchor chain that the DataURL is correct using a proof of the VBA, such as an event emitted from a non-anchor chain.

### Counterfactual Blockchain Naming System

Within a chain cluster—a set of blockchains closely connected using a native interop protocol—it is possible to deploy a blockchain entirely in a counterfactual way, such that the blockchain is never actually deployed but still exists within the blockchain cluster, relying on transactions always being submitted to the other deployed chains in the cluster.

The benefits of counterfactual blockchains include low or no costs for deployment, a fully verifiable state, and gasless transactions. As with all interop solutions, Verifiable Blockchain Artifacts/Actions (VBA) are used as the basis for message passing. In the case of fully counterfactual blockchains, there is no deployed non-anchor chain; therefore, the state of the chain is determined using a virtual machine or protocol that reconstructs the state of the chain based on VBA, such as calldata, events, reverts, and return data on the non-anchor chains. Clients who want to know the state of the chain can query any gateway that maintains the state of the counterfactual chain.

The present invention is a novel protocol, which can also be called a counterfactual blockchain, that significantly reduces the costs associated with registering ENS names without compromising security or decentralization. Unlike existing solutions, the protocol enables cost-effective registrations of subdomains under existing.eth names, such as my.name.eth. It is also possible to use the technology for new TLDs, such as name.newtld. This is achieved through a unique method that involves sending a simple cryptocurrency transfer transaction with specially formatted data in the transaction's calldata, a form of VBA.

However, other types of VBA are possible, including events, reverts, or return data. This innovative approach bypasses the need for executing more complex and costly smart contract operations typical of L1 transactions, thereby offering a scalable and economical alternative for ENS name registration. It is also possible to store the data associated with the transaction on various data availability layers or alternative methods, including using “blobs,” a new method for storing data on the Ethereum blockchain introduced in a protocol upgrade called Dencun.

It is also possible to verify that the computation performed by the indexer was done correctly using zero-knowledge proofs, including zk-SNARK (Succinct Non-Interactive Argument of Knowledge) or zk-STARK (Scalable Transparent Argument of Knowledge) technology.

### Resolving a Name Using Offchain Resolution

It is possible to resolve a sub-name 501, starting with an onchain call to a registry 502, which may use wildcard resolution 505 (ENSIP-10) to find an offchain resolver 504 of the parent name 503 (ERC-3668). Once the resolver is found, a call to the resolver reverts, redirecting the client to resolve the name via a gateway. The client then uses the URL of the gateway to fetch the resolved value, such as the address 508 of the original sub-name 507, from an offchain source such as an indexer 506. It is also possible for the gateway to return a proof along with the final resolved address, which can be verified using the resolver.

### Registering a Name

For example, registering a sub-name of foo.eth using a two-step process includes first sending a commitment 401 to the registrar 406 address (e.g., 0xeee00. . . ) and then sending the registration transaction 402 to the user (e.g., 0xAAA00. . . ). This method prevents front-running.

Commitment:
from: 0xAAA00177999d365004ca044edB53b2Ec6e9D5957
to: 0xeee00BE8b1D919583DA69De2127Aff3d2676658d
value: 0.005 data: data:application/vnd.protocol.
tx;rule=esip6;ensv=0,{
“fn”:“commit”,
“args”:
[“0x21747fb25406a05166438083fc9ce3cdbdd2ecdb”]
}
Batch Commitment:
from: 0xAAA00177999d365004ca044edB53b2Ec6e9D5957
to: 0xeee00BE8b1D919583DA69De2127Aff3d2676658d
value: 0.01
data: “data:application/vnd.protocol.tx;rule=esip6;
ensv=0,{
“fn”:“commit”,
“args”:{
“commitments”:[
“0x21747fb25406a05166438083fc9ce3cdbdd2ecdb”,
“0x21747fb25406a05166438083fc9ce3cdbdd2ecdb”
]
}
}”
User Generated Registration:
from: 0xAAA00177999d365004ca044edB53b2Ec6e9D5957
to: 0xFFF00177999d365004ca044edB53b2Ec6e9D5957
value: 0.000
data: application/vnd.protocol.tx;rule=esip6;
ensv=0,{
“fn”:“register”,
“Args”:[{
“name”:“name.eth”,
“managerAddress”:
“0xAC50cE326de14dDF9b7e9611Cd2F33a1Af8aC039”
,
“salt”:
“0xbf4e417d3179043a9d0ea54eeee8f4e20ab5c45a
62f6bea7b63047d04d70c667”}]
}

It is necessary to wait a number of blocks after a commitment has been made to register a name to ensure that front-running is not possible. Currently, we use a five-block delay. In this embodiment, the DataURL format is used as a signed transaction 405. It is also possible to use other formats, such as the EVM transaction format, the user operation format (such as for ERC-4337 smart accounts), or other formats that include a function selector and arguments.

### Commitments

To make a commitment 401 with one or more names, the owner's address and a secret are concatenated together and hashed using keccak256 to obtain a 32-byte value. With the protocol, we use only the first 20 bytes of the 32-byte value returned by the keccak256 function, starting with the most significant digit. A payment 407 of tokens or the native cryptocurrency of the chain can also be included as part of the commitment.

Solidity:
function makeCommitment(string[] calldata names,
address owner, uint256 secret)
public
pure
returns(bytes20/*signature*/)
{
bytes20 signature = bytes20(keccak256(
abi.encode(
names,
owner,
secret
)
));
return signature;
}

### Zero Knowledge Proofs

The way the protocol works, the user is able to save protocol commands into transactions, including using call data or blobs, and then an offchain indexer interprets the transactions to determine the ownership and metadata associated with each successfully registered name. The operation of the indexer happens offchain, using the protocol to determine the ownership and records of each registered name. To ensure that users do not have to trust the operation of the indexer, it is possible to prove that the computation of the protocol commands is done correctly using zero-knowledge proofs.

The process may include the indexer selecting a batch of transactions, which can be much larger than traditional blocks of popular blockchains and can range from one megabyte to a hundred megabytes, or even hundreds of megabytes. Once a batch of transactions has been created by the indexer, the indexer computes all the protocol operations, leading to a new state for all the names being resolved by the indexer. These batches of transactions can also be called blocks of transactions. It is therefore possible to reconstruct the offchain or counterfactual blockchain at any time in the future in the form of a fully deployed blockchain. The computation by the indexer can be guaranteed to be correct using zero-knowledge proofs, which can be published online using a decentralized data storage provider, a data availability provider, or even onto a blockchain.

One of the properties of zero-knowledge proofs is that it is possible to prove that the computation of protocol operations is correct, even if some of the data is not made public, thus allowing private records, including text and avatar records, to be kept secret and not revealed.

### Synthetic ETH

All the ETH sent to the registrar 407 in transactions results in an equal amount of synthetic ETH being minted for the sender. Synthetic ETH serves as the base currency of the protocol and can be used for registrations and renewals of names. If a registration fails, such as when the name has already been registered, synthetic ETH is refunded to the user. Synthetic ETH does not have to be an ERC-20 token on Ethereum; instead, it can be minted by the indexer when ETH is sent to the registrar in transactions.

### Offchain Pricing

To provide individually priced subdomains, such as assigning a higher price for “john.smith.eth” compared to “pedro.smith.eth,” it is possible to delegate authority to an address for signing per-name priced offers. The signature must adhere to the standard Ethereum signed message format.

$$signature = sign ( keccak 256 ( “ \backslash x 19 Ethereum Signed Message : \backslash n ” + len ( message ) + message ) ) )$$

The message format is a DataURL containing JSON data, using UTF-8 encoding. The content MIME type is application/vnd.protocol.msg. It is also possible to sign batches of names and prices, allowing a single signed message to be used for multiple names.

```
data:application/vnd.protocol.msg;ensv=0,{
  “address”: “0xaC192bF3643D17390eD58a36b9C89cEa7FF2B771”,
  “name”: [“tom.foo.eth”, “jane.foo.eth”],
  “registration-price”: [“100000000”, “150000000”],
  “renewal-price”: [“100000000”, “150000000”],
  “start-date”: “1755538016”,
  “end-date”: “1755538016”
}
```

### Batch Commitment and Registration Attempts

With the protocol, it is possible to create a batch commitment and a batch of registration attempts in a single registration transaction. However, each registration can result in only one name being registered. This ensures interoperability with the Ethscriptions protocol. If all the names in the batch commitment are available, it is necessary to submit the batch registration attempt multiple times to register all the names. This system reduces the number of commitments and enables minting strategies that minimize unfulfilled registration attempts.

```
Batch Commitment:
  from: 0xAAA00177999d365004ca044edB53b2Ec6e9D5957
  to: 0xeee00BE8b1D919583DA69De2127Aff3d2676658d
  value: 0.01 data: “data:application/vnd.protocol.tx;rule=esip6;ensv=0,{
      “p”: “protocol”,
    “op”: “commit”,
    “commit”: “fda58630310a6dd91a7d8f0a4ceda24225637426”
  }”
User Generated Batch Registration Attempt:
  from: 0xAAA00177999d365004ca044edB53b2Ec6e9D5957
  to: 0xAAA00177999d365004ca044edB53b2Ec6e9D5957
  value: 0.000 data: “data:application/vnd.protocol.tx;rule=esip6;ensv=0,{
      “p”: “protocol”,
    “op”: “register”,
    “address”: [“1”,
    “0x4550A0c3533909Acb371281dd013618aE6D376aA”],
    “name”: [“tom.scr.eth”, “jane.scr.eth”],
    “secret”: “12345678”,
    “commit”: “fda58630310a6dd91a7d8f0a4ceda24225637426”,
      “manager”:
      “0xBBB008aeEf55D11ED818bDAE9f2346d594b98D26”
  }”
```

### Registrar

The protocol registrar is a smart contract on L1 Ethereum. It is necessary to send all commitments, offerings, and updated transactions to the registrar contract. Registrations can be directed to whoever will own the successfully registered name, according to the rules of the Ethscriptions protocol. For this protocol, registration transactions should not contain ETH. ETH can be sent with commitment transactions 407. The first version of the registrar is upgradable and fully controlled by the owner of the contract. Over time, it will be possible to progressively decentralize the registrar contract.

### Trading and Listing Names for Sale

Any registration attempt that is formatted correctly can result in a valid registration, either to the sender, to another address or the registrar contract address. Registrations sent to the registrar, results in registering and bridging the name to the owner of the protocol, which is a custodial solution. It is possible to bridge the name back to L1 Ethereum, however, it is not trustless and requires trusting the owner of the protocol. Registrations that are sent directly to the sender, are self custodial because registrations are also Ethscriptions, it is possible to trade names using Decentralized Exchanges (DEX) that support Ethscriptions.

It is however not possible to determine whether a registration attempt has successfully resulted in a registered ENS name. To make sure an registration is valid, it is necessary to use a metadata service to validate the registration as well as display a preview image, which may display the avatar image and the name formatted in a similar way to the ENS metadata service, such as displaying the name over the avatar image.

All successful registrations are fully compatible with the Ethscriptions protocol, however it is not possible to determine a successfully registered name from the calldate of the registration alone. The indexer is needed to determine if a registration attempt is valid or not, and what name is assigned to the transaction.

### Metadata Service

For each successful registration it is possible to access the metadata service to get the name registered, preview image, the owner of the name, the creation date and the expiration date using the original transaction id of the successful registration transaction. Third party marketplaces can use the metadata service to properly display a preview image and properties of registered names.

### Records

ENS supports content records, including text and avatar records. The protocol also supports setting and updating records. Records can be updated by either the owner or the manager of the name.

```
Text and Avatar Record Update:
  from: 0xBBB008aeEf55D11ED818bDAE9f2346d594b98D26
  to: 0xeee00BE8b1D919583DA69De2127Aff3d2676658d
  value: 0.01 data: “data:application/vnd.protocol.tx;rule=esip6;ensv=0,{
      “p”: “protocol”,
    “op”: “update”,
    “name”: “tom.scr.eth”,
    “text”: [“url”, “example.website.com”],
    “avatar”: “ipfs://bafybeigdyrzt5sfp7udm7hu76uh7y26nf3efuylqabf3oclgtqy55fbzdi”,
    “content-hash”:
  “ipfs://bafybeigdyrzt5sfp7udm7hu76uh7y26nf3efuylqabf3oclgtqy55fbzdi”,
  //Note: change the cids for content-hash
  }”
Batch Text Record Update:
  from: 0xBBB008aeEf55D11ED818bDAE9f2346d594b98D26
  to: 0xeee00BE8b1D919583DA69De2127Aff3d2676658d
  value: 0.01 data: “data:application/vnd.protocol.tx;rule=esip6;ensv=0,{
      “p”: “protocol”,
    “op”: “update”,
    “name”: [“tom.scr.eth”, “jane.scr.eth”],
    “text”: [“url”, “example.website.com”], [“url”, “page.website.com”]],
    “avatar”: [“ipfs://bafybeigd...bf3oclgtqy55fbzdi”, “ipfs://bafybeigd...bf3oclgtqy55fbzdi”],
    “content-hash”: [“ipfs://bafybeigd...bf3oclgtqy55fbzdi”,
  “ipfs://bafybeigd...bf3oclgtqy55fbzdi”], //Note: change the cids for content-hash
  }”
```

### Records Parameters

The protocol supports a number of records which can be updated on a name.
alias (string)—A name that should override all the records of the name, except for the ownership and manager of the name.
text (string, string)—A text record including a key and value parameter. Records types are supported according to ENSIP-5.
avatar (string)—An avatar record URI. Data types specified in ENSIP-12 are supported.
content-hash (string)—A content record URI. Content hash according to ENSIP-7 are supported.

The corresponding functions can be called by setting the value of any of the parameters to a smart contract address.

```
function text(address sender, bytes calldata name, string calldata key)
  external
  view
  returns (string value);
function avatar(address sender, bytes calldata name)
  external
  view
  returns (string uri);
function contentHash(address sender, bytes calldata name)
  external
  view
  returns (string uri);
```

### Aliases

It is possible to set an alias on any name that allows a single master name to control the records of other name aliases. Aliases are a default record; therefore, if a name has an alias but also has records set, the records that are set will override the records of the master name. It is also possible to intentionally set some records to a default value, such as a zero address, which is not resolved as an address with ENS, by setting the value to 31 bytes of 0x00, or if it is a string, the equivalent in Solidity, i.e., string (bytes (0x0)).

### Offer Subnames for Sale or for Rent

It is possible for any parent name owner to start offering ENS subnames for rent or for sale using the protocol 403. A valid offer must be sent to the registrar contract by the owner, manager, or an approved address of the parent name, according to the ENS protocol. A subname offer can be updated at any time, but only one offer per name is valid at a time. It is possible to cancel an offer by setting the offer-end-date to the time of the update transaction.

A name owner who wants to offer subnames for sale must also set their resolver 404 to a compatible offchain resolver that allows for fetching records offchain using a gateway, for example, using ERC-3668.

```
Offer Subnames:
  from: 0xAAA00177999d365004ca044edB53b2Ec6e9D5957
  to: 0xeee00BE8b1D919583DA69De2127Aff3d2676658d
  value: 0.1 data: ″data:application/vnd.protocol.tx;rule=esip6;ensv=0,{
      ″fn″: ″offer-subnames″,
    “args” : [{
      ″domain″: ″scr.eth″,
      ″registration-price″: ″0.01″,
      ″renewalPrice″: ″0.01″,
      ″min-length″: ″3″,
      ″max-length″: ″3″,
      ″numbers-only″: true
  }]
  }”
Offer Subnames with Controllers :
  from: 0xAAA00177999d365004ca044edB53b2Ec6e9D5957
  to: 0xeee00BE8b1D919583DA69De2127Aff3d2676658d
  value: 0.1 data: ″data:application/vnd.protocol.tx;rule=esip6;ensv=0,{
      ″p″: ″protocol″,
      ″op″: ″offer-subnames″,
      ″name″: ″foo.eth″,
      ″registration-price″: ″0x15635bC6B952E8d39b67266a511D509fDffBB32e″,
      ″registration-min-duration″: ″31556952″,
      ″registration-max-duration″: ″31556952″,
      ″renewal-price″: ″0x15635bC6B952E8d39b67266a511D509fDffBB32e″
  }″
```

The smart contract, i.e., 0x156 . . . 32e, in this example, used for the registration controller and renewal controller, implements the registrationPrice and renewalPrice functions to determine the price of the registration or renewal. To get a price, the name is encoded using the DNS bytes encoding of the name.

```
function registrationPrice(address sender, bytes calldata name, uint256 duration)
  external
  view
  returns (uint256 weiPrice);
function renewalPrice(address sender, bytes calldata name, uint256 duration)
  external
  view
  returns (uint256 weiPrice);
```

Controllers can be used to allow for variable or per-name specific pricing. For registrations, the price can be changed by the parent name owner who is offering the subnames at any time unless the price is burned, i.e., “registration-price-burn,” wherein the value cannot be changed. The number 0 is a valid response and should be interpreted to mean no cost.

### Renewal Controllers

Renewal Controllers are controllers that set the price for renewals of subnames. Unlike registration controllers, Renewal Controllers are automatically burned into the subname, and cannot be changed by the parent name owner, after the subname has been minted. The Renewal Controller can however be changed at any time by the parent name owner by updating the offer, which will affect any names that are registered after the change takes place. It is also possible to use the “-burn” fuse to burn this ability to update the offer with a new renewal controller.

### Allow Lists

It is possible to create an allowlist with a list of addresses allowed to register names using a registration controller. If the address is not allowed to register a name the registrationPrice function will revert.

### Offchian Pricing

In the case where a subnames are offered with individual registration pricing for each name, for example john.smith.eth could be priced differently than pedro.smith.eth, it is possible to submit a registration along with a signed message, which is then verified by a smart contract on mainnet, that can verify the signature and the registration price.

```
User Generated Registration with Signature:
  from: 0xAAA00177999d365004ca044edB53b2Ec6e9D5957
  to: 0xFFF00177999d365004ca044edB53b2Ec6e9D5957
  value: 0.000
  data:application/vnd.protocol.tx;rule=esip6;ensv=0,{
    ″fn″: ″register″,
    ″Args″:[{
      “name”:″name.eth″,
      “managerAddress”:″0xAC50cE326de14dDF9b7e9611Cd2F33a1Af8aC039″
    ,
      “salt”:″0xbf4e417d3179043a9d0ea54eeee8f4e20ab5c45a62f6bea7b6304
    7d04d70c667″,
      “weiPrice”: “1000000”,
      “signature”: “0xf4a3b25e8d6c4178a2f3959b4b9e1237c48fd5612a9b8d7
    e6f3a4c5d6e7f8091a2b3c4d5e6f70123456789abcdeffedcba9876543210fedcba9
    87654321”
      “expiration”: “0x65B040E9”
        }]
  }
```

### Renew Subnames

When a subname needs to be renewed it is possible to renew the subname.

```
Renew Subname:
  from: 0xF18dC3A610a989810FF86E8296DBEc7Cc6a0653a
  to: 0xeee00BE8b1D919583DA69De2127Aff3d2676658d
  value: 0.01 data: ″data:application/vnd.protocol.tx;rule=esip6;ensv=0,{
    ″p″: ″protocol″,
    ″op″: ″renew″,
    ″name″: ″tom.foo.eth″,
    ″duration″: ″63113904″
  }”
Renew Subname Batch:
  from: 0xF18dC3A610a989810FF86E8296DBEc7Cc6a0653a
  to: 0xeee00BE8b1D919583DA69De2127Aff3d2676658d
  value: 0.01 data: ″data:application/vnd.protocol.tx;rule=esip6;ensv=0,{
    ″p″: ″protocol″,
    ″op″: ″renew″,
    ″name″: [″tom.foo.eth″, ″jane.foo.eth″],
    ″duration″: [″63113904″,″63113903″]
  }″
```

### Protocol Upgrade and Fee Changes

It will be necessary from time to time to upgrade the protocol. All transactions that take place on L1 Ethereum will be processed off-chain using the version of the protocol from the last update notice posted on L1 Ethereum. The version of the protocol will be emitted as an event from the registrar.protocol.eth smart contract. Currently, the protocol charges a fee for all registrations, renewals, and setting up a new subname offering. Percentages use six digits of precision, and fees use 18 digits of precision.

```
event versionUpdate(
  string indexed name
);
event registrationFeeUpdate(
  uint256 indexed percentage
);
event renewalFeeUpdate(
  uint256 indexed percentage
);
event newOfferingFeeUpdate(
  uint256 indexed fee
);
```

### Disable Allow List

We are currently working with a limited number of ENS name owners to offer subnames. The protocol currently has an allowlist that can be updated using events. The allowlist can also be permanently disabled using a burn event.

```
event addToAllowList(
  string[ ] indexed names
);
event removeFromAllowList(
  string[ ] indexed names
);
event burnAllowList( );
```

### Permanent Immutable Records

A number of records have the ability to be locked. Some examples of locked records are records set using the “update” operation, such as “address-lock,” “avatar-lock,” and “text-lock.” For each parameter, its specification will indicate whether the parameter can be locked or not. Locked parameters should be considered locked permanently, but in reality, the behavior of locked parameters is governed by the protocol.

It is possible that future upgrades to the protocol could allow for locked parameters to be unlocked or modified under certain conditions. For example, if a protocol like IPFS were to change the way that CIDs work in the future, it might be possible to allow for locked content-hash records to be upgraded to the new IPFS format. Any changes to locked records should only be made to address protocol-wide issues that might arise in the future and should not be used to fix mistakes made by individuals. For this reason, anyone using locked records should proceed with an abundance of caution.

### Trust and Decentralization

Currently, any names that are registered using the protocol are resolved off-chain using the ENS protocol feature CCIP-Read, which allows for off-chain resolution using a gateway. It is also possible for the owner of the parent ENS name to register onchain subnames, which override off-chain names. It is possible for the protocol to become a completely trustless decentralized protocol; however, it requires that the protocol become widely adopted and recognized by clients like wallets that are responsible for ENS name resolution.

CCIP-Read allows for resolvers of ENS names to revert and pass a URL of a gateway to a client who is trying to resolve an ENS name. Currently, the client blindly requests the data from the gateway that is provided; however, in the future, it would be possible for the client to recognize the URL of the gateway, http://gateway.theprotocol.com, to indicate that the name should be resolved using the protocol, which is fully deterministic and verifiable. Clients would then be able to verify the data returned from the gateway using their own independent verification service.

Because the protocol uses L1 Ethereum transactions to record all changes to ENS names, it is possible to recreate the state of any names registered using the protocol by anyone, which can be done in a decentralized way. Once the protocol is widely adopted, it would also be possible for parent name owners to burn fuses on their names that would not allow them to change the gateway URL or create onchain subnames. The steps to make the protocol trustless include:
Establish the protocol with a centralized gateway and parent name owners who need to be trusted to keep the resolver set to the gateway and not to override the gateway with onchain subnames.
Establish independent implementations and gateways provided by independent organizations. Add the gateways to the resolver for redundancy and consensus.
Decentralize the gateways. There are many ways to do this, including the client running their own gateway to validate the official gateway and creating a consensus mechanism for multiple gateways to agree on the computation.
Parent name owners burn their ability to change their resolver or change the list of gateways in the resolver. This would be permanent and could only be undone by the ENS DAO if the protocol ever became inoperable.
After the fourth step, a name using the protocol would be trust-minimized and decentralized, comparable to using L1 smart contracts; however, most of the computation would be handled off-chain, dramatically reducing the costs, anywhere from 2 to 20 times.

Synthetic ETH is a synthetic version of ETH used within the protocol, primarily for off-chain computation. Unlike ETH, synthetic ETH allows for necessary transactions without requiring refunds, which are not feasible off-chain. While synthetic ETH (esETH) can be converted back to ETH and withdrawn through the registrar contract, this process requires verification by the gateway, making it non-trustless. However, esETH can also be used directly for ENS name registrations and renewals, avoiding the high gas costs associated with converting back to ETH.

This is comparable to postal stamps—while they can sometimes be exchanged for cash, it is usually simpler and more efficient to use them for mailing. Third-party bridges may facilitate esETH-to-ETH conversion, but these will also be permissioned services, intentionally designed to minimize complexity and reliance on smart contracts.

The protocol charges fees to parent name owners who use it to offer subnames, currently set at 2.5% of all registrations and renewals, with no additional fee for new subname offerings at this time. Unlike traditional smart contract-based solutions, which are costly on L1 Ethereum, this protocol leverages inscription technology to scale ENS more efficiently. While L2 solutions exist, they are still in the early stages, often centralized, and come with potential censorship and reliability concerns. The protocol aims for a simpler, lower-cost alternative to scaling ENS.

Security-wise, the current implementation is centralized, requiring trust in the ENS parent name owner. However, if widely adopted, L1 transaction data would ultimately determine name ownership, and parent name owners would need to lock their names into the protocol. In such a scenario, it could achieve a level of security and trustlessness comparable to L1 smart contracts at a significantly lower cost. The protocol also includes a bridge that allows ETH to be converted to synthetic ETH and withdrawn back to ETH on L1, requiring both a gas fee and a signed message from the bridge controller to facilitate the conversion.

### Blockchain Technology

Blockchains are decentralized, distributed ledgers that securely record transactions using cryptographic techniques and consensus mechanisms, allowing participants to verify data without a central authority. These systems comprise both hardware and software components, where hardware includes processors (CPUs, GPUs, ASICs, and FPGAs for mining and validation), volatile and non-volatile memory, storage devices, networking interfaces for peer-to-peer communication, and other computational infrastructure. Blockchain software includes consensus algorithms such as Proof of Work and Proof of Stake, cryptographic hash functions, digital signatures, and smart contracts, which are self-executing programs that enforce transaction rules and automate business logic.

Blockchain networks may be permissionless, allowing open participation, or permissioned, restricting access to authorized entities, and they may implement various scaling techniques such as sharding, rollups, and cross-chain communication protocols to enhance efficiency and interoperability. The term “blockchain” as used herein may refer to a single blockchain or a plurality of blockchains working in coordination, and any reference to an element in the singular should be understood to encompass one or more of such elements unless explicitly stated otherwise.

A blockchain node is any computing device participating in a blockchain network, with full nodes storing and validating the entire ledger, light nodes relying on partial verification, and specialized nodes such as miners or validators contributing to consensus. Transactions within a blockchain are digitally signed messages altering the ledger state, leveraging public-key cryptography and cryptographic hashing to ensure security and immutability.

Blockchain networks operate using peer-to-peer protocols, enabling globally distributed systems that support applications ranging from financial transactions to decentralized identity management. Smart contracts, deployed on blockchain networks, interact with external data sources through oracles and execute predefined logic based on onchain and off-chain inputs. To facilitate seamless user experiences, blockchain wallets increasingly incorporate chain abstraction, enabling users to transact across multiple blockchains without being aware of the underlying network structure, while cross-chain bridges and interoperability protocols allow for the movement of assets and data between disparate blockchain ecosystems.

The embodiments described herein are illustrative and not intended to be limiting, as various modifications, substitutions, and equivalent implementations may be applied without departing from the scope of the invention. The disclosed technology may be implemented entirely in hardware, entirely in software, or through a combination of both, utilizing general-purpose computing devices or specialized cryptographic hardware.

The principles and techniques described may be adapted for different blockchain architectures, consensus models, security frameworks, and network configurations, including but not limited to decentralized applications, AI-driven agents, and large-scale blockchain clusters designed to support millions or billions of users. Any specific examples provided are for illustrative purposes only, and the scope of the invention should be determined by the claims rather than any particular implementation detail. The use of specific terminology should not be construed as limiting, as equivalent alternatives, variations, and combinations of elements may be employed to achieve the same or similar functionality.

1. A method for registering identity records using VBA comprising:
Sending a commit operation with payment from a blockchain name renter, using VBA to encode the commitment details to a first blockchain of a blockchain cluster without storing the commitment in the persistent storage of the chain;
Sending a registration operation from the renter, using VBA, including a commitment hash, secret, and at least one blockchain name to the first blockchain without storing ownership data in the persistent storage of the chain;
Processing the VBA to create a message, including an operation to register the at least one blockchain name in a registry;
Registering the at least one blockchain name;
and resolving the blockchain name.

2. The method of claim 1, wherein registering the at least one blockchain name uses a blockchain interop protocol to register the blockchain name on an anchor chain, beginning with a transaction being sent to a non-anchor chain.

3. The method of claim 1, wherein there is a delay between the commitment and the registration transaction to prevent front-running.

4. The method of claim 1, wherein identity records are stored in a counterfactual blockchain.

5. The method of claim 1, wherein a synthetic crypto asset is credited to the renter in direct proportion to the native crypto asset sent to the registrar during transactions and its use in subsequent registrations and renewals of blockchain names.

6. The method of claim 1, wherein off-chain pricing is used, allowing for individualized pricing for name registrations and renewals using signed messages verified by smart contracts.

7. The method of claim 1, wherein identity records of a single identity are registered both in an anchor chain and a non-anchor chain within a chain cluster, and wherein resolving the identity can happen with a single multicall to the anchor chain.

8. The method of claim 1, wherein avatar and text records are updated on a name using update VBA transactions.

9. The method of claim 1, wherein the indexer generates zero-knowledge proofs to verify changes to name data, including ownership.

10. The method of claim 1, wherein a commitment is not used, and payment can be included with the registration transaction.

11. A method for registering a record of an identity using a counterfactual blockchain comprising:
Sending an add record operation to a blockchain using VBA;
Processing the VBA using a gateway to generate a message directed to a counterfactual chain;
Sending an add record operation to the counterfactual chain to add an identity record to the persistent storage of the counterfactual chain;
and registering the identity record.

12. The system of claim 11, wherein the formatted data adheres to a predefined schema, including using data URLs and JSON formatting.

13. The system of claim 11, wherein batch commitments can be performed to streamline the process of registering multiple records simultaneously.

14. The system of claim 11, wherein a synthetic crypto asset is credited to the renter in direct proportion to the native crypto asset sent to a registrar during transactions and its use in subsequent registrations of identity records.

15. The system of claim 11, wherein avatar and text records are updated on a name using update inscription transactions.

16. The system of claim 11, wherein the indexer of the counterfactual blockchain generates zero-knowledge proofs to verify changes to name data, including ownership.

17. The system of claim 11, wherein the counterfactual chain is an EVM chain.

18. The system of claim 11, wherein the identity record is context for an agent.

19. The system of claim 11, wherein the identity is used to create a secure MCP server.

20. The system of claim 11, wherein the identity is used as the identity of a fully onchain app using the DataURL format.
